(19) United States
(12) Patent Application Publication
(10) Pub. No.: US 2024/0095636 A1
(43) Pub. Date: Mar. 21, 2024

(54) CLINICAL INVESTIGATION TIMELINESS PREDICTOR

(71) Applicants: MSD Czech Republic s.r.o., Prague (CZ); Merck Sharp & Dohme LLC, Rahway, NJ (US)

(72) Inventors: Ioannis Spyroglou, Prague (CZ); Chad Rutt, Philadelphia, PA (US)

(21) Appl. No.: 18/465,645

(22) Filed: Sep. 12, 2023

(30) Foreign Application Priority Data
Sep. 12, 2022 (GR) 20220100737

(51) Int. Cl. G06Q 10/0635

(52) U.S. Cl. CPC G06Q 10/0635

(57) ABSTRACT

A clinical investigation management system monitors clinical investigations performed across departments and clinical investigators. The system employs a method for predicting timeliness in completion of clinical investigations. The method includes monitoring data of a clinical investigation performed by a clinical investigator. The method includes applying a timeliness model to the data to determine a timeliness prediction of the clinical investigation. The method includes identifying one or more interventive actions based on the timeliness prediction. The method includes generating a notification including the timeliness prediction and the identified one or more interventive actions. The method includes transmitting the notification to a client device of a supervisor.

### TECHNICAL FIELD

This disclosure relates generally to clinical investigations and predicting the timeliness of such investigations.

### BACKGROUND

A significant percentage of good manufacturing practice (GMP) deviation investigations are not closing on the specified time. The various factors that can contribute to the untimeliness are obscured and not readily discernible. However, understanding the timeliness of the investigations as they progress is valuable in timely completion of investigations prior to Quality Assurance approval. Without such insight, interventive actions enacted to mitigate untimely investigations lead to wasted resources and ineffective improvement of timeliness. Accordingly, there is a need for ongoing prediction of timeliness of investigations.

### SUMMARY

Broadly speaking, a clinical investigation management system monitors clinical investigations performed across departments and clinical investigators. The clinical investigation management system employs a timeliness prediction model that is configured to predict timeliness of clinical investigations based on the monitored data. Such timeliness prediction provides detailed insight into investigations as the investigations progress. The clinical investigation management system may further identify interventive actions based on the timeliness prediction. Such interventive actions may be aimed at investigations that are likely to be overdue, thereby limiting wasted resources on investigations predicted to be timely. The clinical investigation management system may generate and transmit a notification with the timeliness prediction and the one or more interventive actions. In some embodiments, the clinical investigation management system generates a graphical user interface (GUI) to display the monitored data of the clinical investigation(s) and the timeliness prediction(s). The GUI may be configured with togglable inputs, allowing a supervisor to simulate interventive actions to understand potential effects on the timeliness.

The timeliness model aims to reduce waste of resources by providing insight on how to efficiently allocate interventive resources. Such cost-saving measures streamline clinical investigations and provides greater predictability. Moreover, the timeliness model may be used to simulate interventive actions, thereby allowing a supervisor or other related management personnel to preemptively compare effects certain interventive actions may have. The timeliness model may also be implemented in a notification system that automatically provides interventive actions when the timeliness prediction satisfies a trigger.

### BRIEF DESCRIPTION OF DRAWINGS

The disclosed embodiments have advantages and features which will be more readily apparent from the detailed description, the appended claims, and the accompanying figures (or drawings). A brief introduction of the figures is below.

Figure (FIG. 1 is a block diagram of a networked computing environment suitable for predicting timeliness of clinical investigations, according to one or more embodiments.

FIG. 2 is a block diagram of the clinical investigation management system of FIG. 1, according to one or more embodiments.

FIG. 3 is a workflow of predicting timeliness of clinical investigations, according to one or more embodiments.

FIG. 4A is a flowchart illustrating training a timeliness model, according to one or more embodiments.

FIG. 4B is a flowchart illustrating predicting timeliness for a clinical investigation using the timeliness model, according to one or more embodiments.

FIG. 5A is a first graph illustrating the effect on timeliness that a clinical reviewer's years of experience (square root) has combined with clinical investigator's workload (the smaller the number of days from last investigation, the higher the workload, also square root), according to one or more example implementations.

FIG. 5B is a second graph illustrating the effect on timeliness that a vacation period has combined with clinical investigator's workload, according to one or more example implementations.

FIG. 5C is a third graph illustrating the effect on timeliness that a clinical reviewer's investigation experience has (measured in number of investigations), according to one or more example implementations.

FIG. 6A is a table with accuracy metrics of the timeliness model, according to one or more example implementations.

FIG. 6B is a graph time series cross-validation when training the timeliness model, according to one or more example implementations.

FIG. 7A illustrates a first portion of an example graphical user interface, according to one or more example implementations.

FIG. 7B illustrates a second portion of an example graphical user interface, according to one or more example implementations.

FIG. 8A illustrates an example graphical user interface prior to intervention, according to one or more example implementations.

FIG. 8B illustrates the example graphical user interface of FIG. 8A post intervention, according to one or more example implementations.

FIG. 9 illustrates an example graphical user interface, according to one or more example implementations.

FIG. 10 a block diagram illustrating components of an example machine able to read instructions from a machine-readable medium and execute them in a processor (or controller), according to one or more embodiments.

### DETAILED DESCRIPTION

Reference will now be made in detail to several embodiments, examples of which are illustrated in the accompanying figures. It is noted that wherever practicable similar or like reference numbers may be used in the figures and may indicate similar or like functionality. Where similar or like elements are identified by a common numeral followed by a different letter, a reference to the numeral alone may refer to any such element or combination of such elements (including all such elements). One skilled in the art will readily recognize from the following description that alternative embodiments of the structures and methods illustrated herein may be employed without departing from the principles described.

### Clinical Investigation Management System Overview

Broadly speaking, a clinical investigation management system monitors clinical investigations performed across departments and clinical investigators. The clinical investigation management system employs a timeliness model that is configured to predict timeliness of clinical investigations based on the monitored data. The clinical investigation management system may further identify interventive actions based on the timeliness prediction. The clinical investigation management system may generate and transmit a notification with the timeliness prediction and the one or more interventive actions. In some embodiments, the clinical investigation management system generates a graphical user interface (GUI) to display the monitored data of the clinical investigation(s) and the timeliness prediction(s). The GUI may be configured with togglable inputs, allowing a supervisor to simulate interventive actions to understand potential effects on the timeliness.

Figure (FIG. 1 is a block diagram of a networked computing environment 100 suitable for predicting timeliness of clinical investigations, according to one or more embodiments. In the embodiment shown, the networked computing environment 100 includes a clinical investigation management system 110, a set of datastores 120, and a set of client devices 130, all connected via a network 190. In other embodiments, the networked computing environment 100 includes different and/or additional elements. In addition, the functions may be distributed among the elements in a different manner than described.

The clinical investigation management system 110 employs a timeliness model that is configured to predict timeliness of clinical investigations based on the monitored data. The clinical investigation management system may further identify interventive actions based on the timeliness prediction. The clinical investigation management system may generate and transmit a notification with the timeliness prediction and the one or more interventive actions. In some embodiments, the clinical investigation management system generates a graphical user interface (GUI) to display the monitored data of the clinical investigation(s) and the timeliness prediction(s). The GUI may be configured with togglable inputs, allowing a supervisor to simulate interventive actions to understand potential effects on the timeliness. The clinical investigation management system 110 connects to the datastores 120 that may include information relating to historical clinical investigations, e.g., including whether the clinical investigations were completed on time or were overdue (not on time). The clinical investigation management system 110 may further connect to the client devices 130, e.g., for monitoring the current active clinical investigations, for providing various notifications, for displaying the graphical user interface, etc.

In one embodiment, the datastores 120 store information relating to the clinical investigations. Clinical investigation data for a clinical investigation may include, but is not limited to, size of the investigation, one or more clinical investigators assigned to the investigation throughout duration of the investigation, a targeted completion window, an actual completion window, additional information on the clinical investigators, external factors caused by third-party vendors, etc. Each type of data may be stored in its own datastore.

The client devices 130 are computing devices with which users may access the change assessment functionality provided by the clinical investigation system 110. Although three client devices 130A, 130B, and 130N are shown in FIG. 1, the networked computing environment 100 may include any number of client devices 130. In one embodiment, a client device 130 is a computer system, such as a desktop or a laptop computer. Alternatively, a client device 130 may be a device having computer functionality, such as a personal digital assistant (PDA), a mobile telephone, a smartphone, or other suitable device. A client device 130 may execute software (e.g., an application) enabling a user of the client device 130 to interact with the clinical investigation system 110 via the network 190. For example, a client device 130 may execute a browser application that displays a user interface generated by the clinical investigation system 110.

The datastores 120, clinical investigation system 110, and client devices 130 are configured to communicate via the network 190, which may include any combination of local area and/or wide area networks, using both wired and/or wireless communication systems. In one embodiment, the network 190 uses standard communications technologies and/or protocols. For example, the network 190 may include communication links using technologies such as Ethernet, x802.11, worldwide interoperability for microwave access (WiMAX), 3G, 4G, 5G, code division multiple access (CDMA), digital subscriber line (DSL), etc. Examples of networking protocols used for communicating via the network 190 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 190 may be represented using any suitable format, such as hypertext markup language (HTML) or extensible markup language (XML). In some embodiments, all or some of the communication links of the network 190 may be encrypted using any suitable technique or techniques.

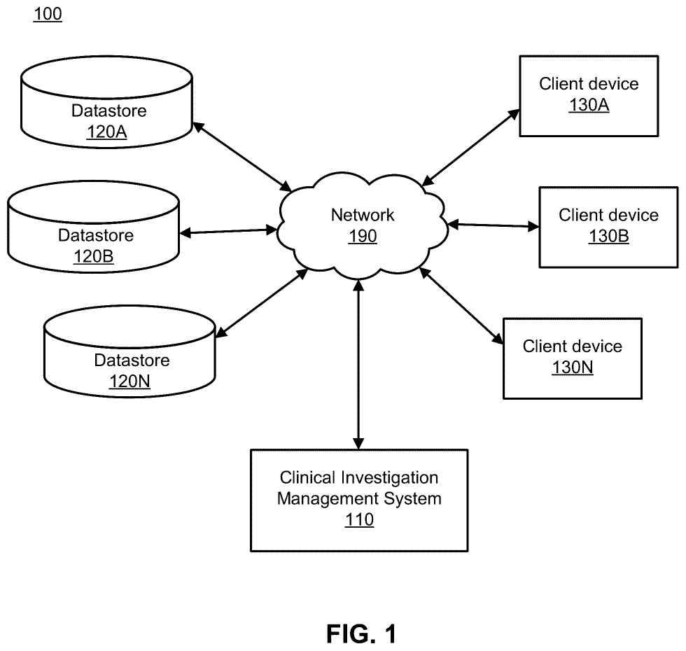

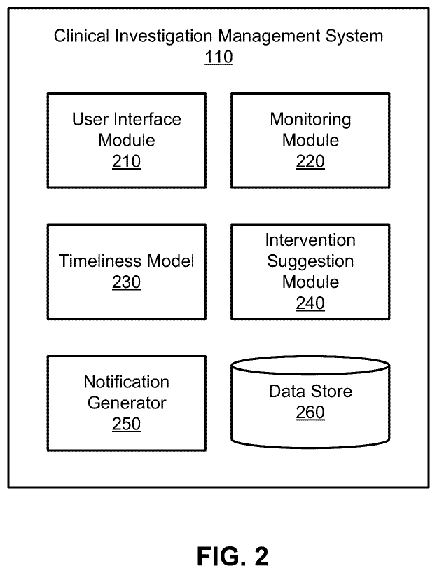

FIG. 2 is a block diagram of the clinical investigation management system of FIG. 1, according to one or more embodiments. In the embodiment shown, the clinical investigation system 110 includes a user interface module 210, a monitoring module 220, a timeliness model 230, an intervention suggestion module 240, a notification generator 250, and a datastore 260. In other embodiments, the clinical investigation system 110 includes different and/or additional elements. In addition, the functions may be distributed among the elements in a different manner than described.

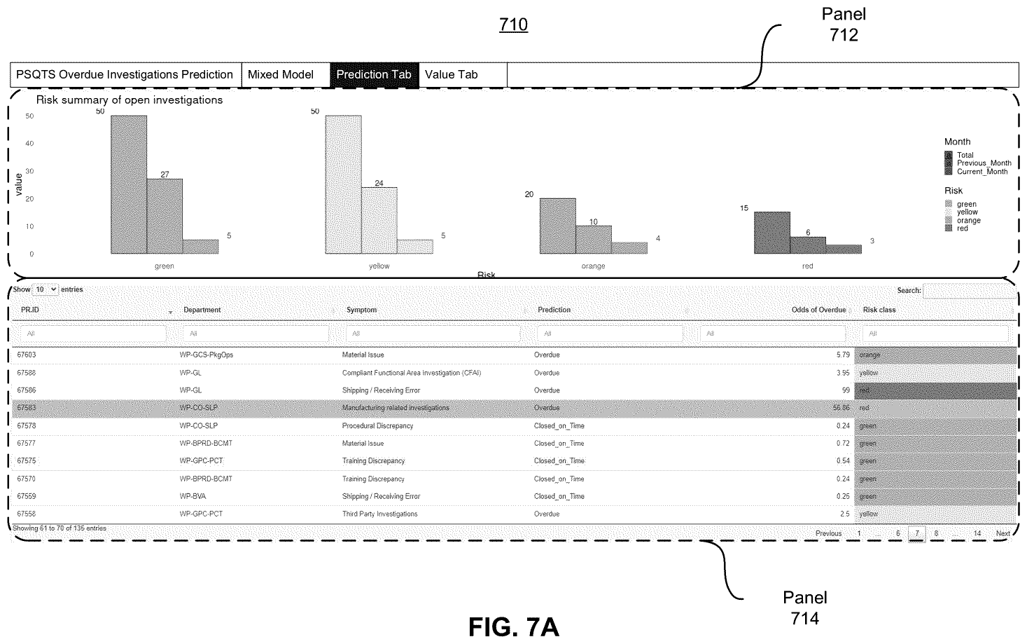

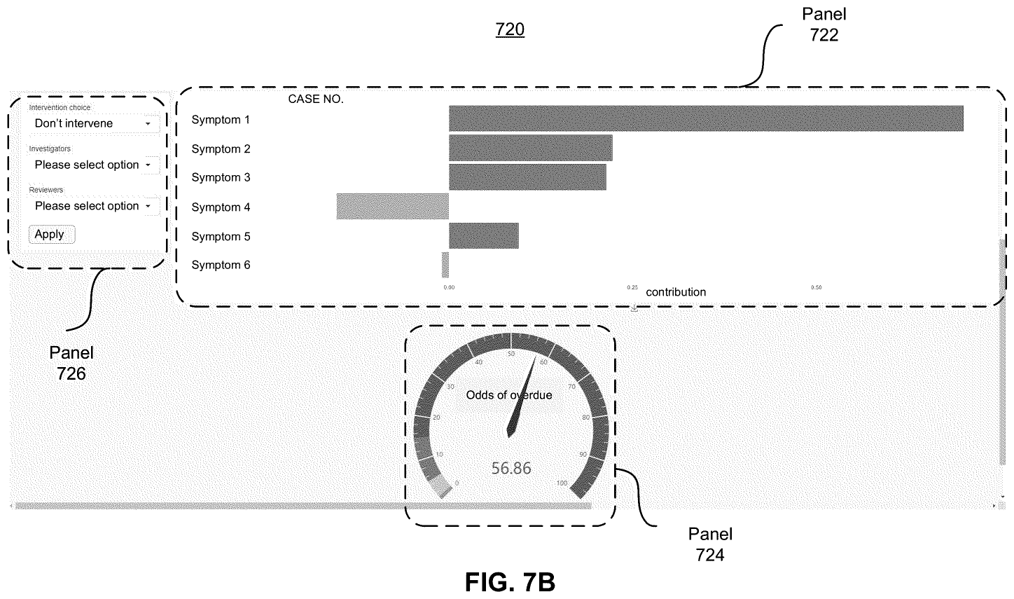

The user interface module 210 generates a user interface and provides it to the client devices 130 for display to users. The user interface is configured to provide information relating to the clinical investigations to a supervisor or other user. In some embodiments, the user interface is a graphical user interface (GUI) displaying the relevant information graphically. The GUI may further include togglable inputs. The user may provide inputs via the togglable inputs on the GUI. The user interface module 210 may provide such inputs to other components of the clinical investigation management system 110. The other components may provide updated information based on the received inputs. The user interface module 210 may update the GUI based on the updated information. Example graphical user interfaces are further described below in FIGS. 7A, 7B, 8A, 8B, and 9.

The user interface module 210 may further employ security measures to ensure authorized access to the clinical investigation information. Security measures may include username and password logins for authorized users, implementing strong authentication, strong passwords, etc.

The monitoring module 220 monitors the clinical investigations managed by the clinical investigation management system 110. The monitoring module 220 may pull the relevant data from other datastores 120 or from client devices 130, e.g., via the network 190. For example, the monitoring module 220 may pull information like size, start date, progress, etc., from a datastore. The monitoring module 220 may also pull information relating to the clinical investigator in another datastore storing profiles of each clinical investigator. The monitoring module 220 may also pull information on one or more reviewers, reviewing the investigations of the clinical investigators. The monitoring module 220 may also track external factors from third-party vendors. Example external factors include delays of shipping purchased equipment and supplies, quality control issues, etc. All the data collected relating to the clinical investigations may be termed “monitored data.” The monitoring module 220 may forward the monitored data to the timeliness model 230. Each of the types of monitored data may be termed a “factor” of the clinical investigation. For example, a first factor is a target completion window for the clinical investigation. For a particular clinical investigation, the first factor may be 60 days, with another clinical investigation having a value of 75 days for the first factor.

The timeliness model 230 predicts timeliness of a clinical investigation based on the monitored data of the clinical investigation. The timeliness model 230 may input the monitored data as a feature vector and output the timeliness prediction. The timeliness model 230, generally, includes a function and a plurality of weights that transform the feature vector into the timeliness prediction. In one or more embodiments, the timeliness model 230 includes a plurality of sub-models that may be trained separately based on discrete values of a first factor. For example, a sub-model may be trained for each department as the first factor. With a current clinical investigation, the timeliness model 230 may apply the appropriate sub-model corresponding to the department or/and clinical symptom.

The timeliness prediction may indicate a likelihood of the clinical investigation completing on time or not. For example, the timeliness prediction may be a binary prediction: (1) on-time, or (2) overdue. The timeliness prediction may indicate the likelihood, e.g., 60% likely to be on-time, or 40% likely to be overdue. The timeliness prediction may also indicate one or more factors that are contributing to the timeliness prediction. For example, a particular clinical investigation is likely to be overdue with the clinical investigator's limited experience as a primary factor contributing to the overdue prediction.

The clinical investigation management system 110 trains the timeliness model 230 using previously completed clinical investigations. The completed clinical investigations may include the monitored data and a timeliness result of the clinical investigation. The timeliness result may indicate whether the clinical investigation completed or finished on-time or was overdue. The clinical investigation system 110 generates a feature vector for each past clinical investigation based on their monitoring data. The clinical investigation system 110 feeds the features vectors as training data to train the timeliness model 230 to predict the timeliness results of the training data. Training generally entails adjusting the weights, refining an architecture of the model, learning hyperparameters of the model, learning other trainable features of the model, or some combination thereof.

The timeliness model 230 may be trained as a machine-learning model. Example machine-learning models include regression-type models, e.g., linear regression, logarithmic regression, exponential regression, multivariate regression, polynomial regression, lasso regression, etc. Other example machine-learning models include classification-type models, like logistic regression. Other machine-learning techniques that may be implemented include kernel methods, random forest classifier, a mixture model, an autoencoder model, machine learning algorithms such as multilayer neural networks, etc.

The clinical investigation management system 110 may store the trained model, e.g., in the data store 260. In other embodiments, the trained timeliness model 230 may be stored on a computer program product for execution by other computing devices.

The intervention suggestion module 240 identifies one or more interventive actions based on the timeliness prediction. The various interventive actions may be stored, e.g., in the data store 260. The intervention suggestion module 240 may track prior use of interventions on particular clinical investigations and the success or failure of those interventions. For example, if providing weekly reminders to a clinical investigator has not proven fruitful in past clinical investigations, then the intervention suggestion module 240 may be less likely to suggest such intervention. In some embodiments, the intervention suggestion module 240 may suggest interventions based on a severity of being overdue, e.g., a high likelihood of being overdue. In some embodiments, the intervention suggestion module 240 may utilize triggers to trigger suggestion of an interventive action. For example, once the odds of overdue surpasses the number 15, then suggest an interventive action. In one or more embodiments, the intervention suggestion module 240 may utilize a suggestion model, e.g., trained as a machine-learning model. Types of interventions may be the replacement of a clinical investigator or/and reviewer based on the workload and experience respectively.

The notification generator 250 generates and transmits notifications regarding the timeliness prediction. The notification generator 250 may generate a notification including the timeliness prediction and the one or more identified interventive actions (e.g., suggested by the intervention suggestion module 240). The notification may further include actionable inputs based on the identified interventive actions. For example, one intervention for providing a reminder to the clinical investigator can include an action to send the reminder. The notification may be formatted in any of a number of forms, e.g., in an email report, in a GUI, in a pop-up notification, etc. The notification generator 250 may transmit the notification, or may provide the notification to the user interface module 210 to present in the GUI. As interventions are suggested by the intervention suggestion module 240, the notification generator 250 may automatically provide suggested interventions to a supervisor managing one or more clinical investigations.

The data store 260 stores data used by the clinical investigation management system 110. The data store 260 may be an embodiment of the datastores 120, e.g., generally comprising a computer-readable storage medium capable of storing computer-executable instructions or computer-readable data. In one or more embodiments, the data store 260 stores monitored data on the clinical investigation (past and active), profiles for clinical investigators, history of interventive actions, one or more trained models (e.g., the timeliness model 230 and/or a suggestion model).

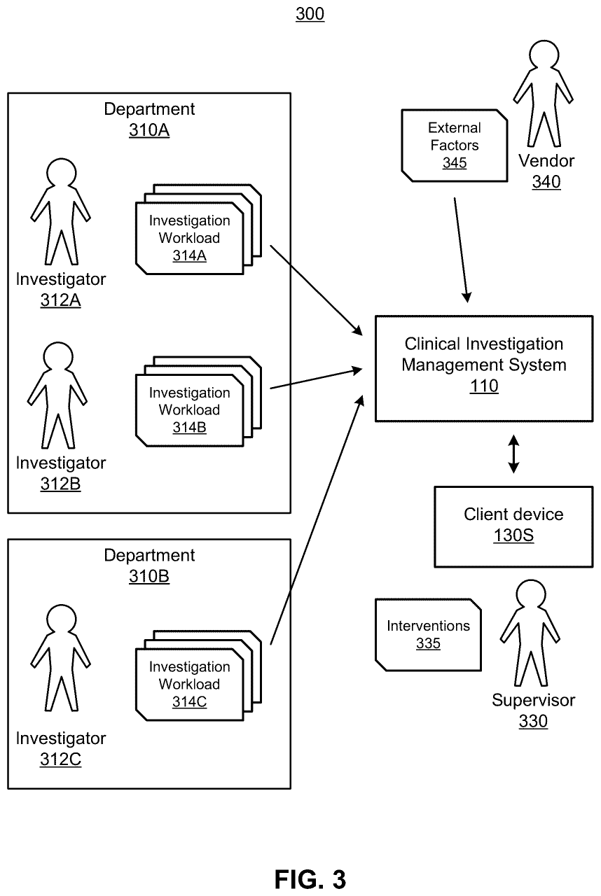

FIG. 3 is a workflow 300 of predicting timeliness of clinical investigations, according to one or more embodiments. In the example workflow 300, there are multiple departments 310 (namely department 310A and department 310B) managed by the clinical investigation management system 110. Each department 310 has one or more investigators 312 with their own investigation workload 314 and one or more reviewers 316. In other embodiments, departments may be variably structured, e.g., reviewers 316 may review work across departments. In the example, department 310A has investigator 312A with investigation workload 314A, investigator 312B with investigation workload 314B, and reviewer 316A reviewing and overseeing the investigators 312A and 312B; and department 310B has investigator 312C with investigation workload 314C and reviewer 316B reviewing and overseeing the investigator 312C. The clinical investigation management system 110 further communicates with a supervisor 330 and a third-party vendor 340. In other embodiments, there may be additional or fewer entities than shown in FIG. 3.

The clinical investigation management system 110 gathers monitored data relating to the clinical investigations from the departments 310, the clinical investigators 312, the vendor 340, the supervisor 330, or some combination thereof. The clinical investigation management system 110 predicts timeliness of the clinical investigations in the investigation workloads 314. The clinical investigation management system 110 may generate and provide a notification of the timeliness predictions to the supervisor 330. As described above in FIG. 2, the notification may further include one or more suggested interventions. The supervisor 330, armed with knowledge of the timeliness predictions, may enact one or more interventions 335 (that may be suggested by the clinical investigation management system 110). In some embodiments, the clinical investigation management system 110 may provide a GUI with actionable inputs to employ the suggested interventions. In other embodiments, the clinical investigation system 110 may be configured to automatically employ interventive actions when triggering criteria are met, e.g., send email reminder to clinical investigator when timeliness prediction is more than 50% likely to be overdue.

Various example user interfaces for the various processes described above are shown in Appendix A, which makes up a part of this disclosure and specification. Note that Appendix A depicts only example embodiments and any statements therein that imply a particular feature is required or necessary should be construed as relating only to the depicted embodiment and not that the feature is present in all embodiments. Furthermore, features of different embodiments may be combined unless the context clearly indicates otherwise.

### Example Methods

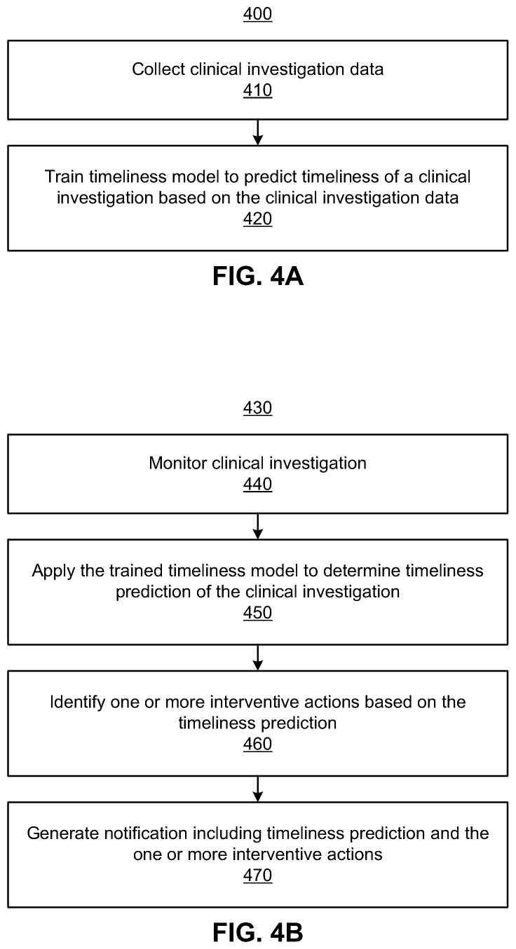

FIGS. 4A & 4B illustrate example methods relating to predicting timeliness of clinical investigations. The steps of 4A & 4B are illustrated from the perspective of various components of the clinical investigation system 110 performing the methods. However, some or all of the steps may be performed by other entities and/or components. In addition, some embodiments may perform the steps in parallel, perform the steps in different orders, perform multiple iterations of one or more steps, or perform different steps.

FIG. 4A is a flowchart illustrating training a timeliness model (e.g., the timeliness model 230), according to one or more embodiments. The clinical investigation system 110 performs the training of the timeliness model using training data from past clinical investigations.

The clinical investigation system 110 collects 410 the clinical investigation data from the past clinical investigations. The terms “past clinical investigation,” “completed clinical investigation,” and “historical clinical investigation” are synonymous and may be used interchangeably. Each past clinical investigation includes the monitored data and a timeliness result. The timeliness result includes similar information as the timeliness prediction, e.g., whether on-time or overdue.

The clinical investigation system 110 trains 420 the timeliness model to predict timeliness of a clinical investigation based on the clinical investigation data. The clinical investigation system 110 may generate a feature vector for each past clinical investigation based on its monitored data. The clinical investigation system 110 may train the timeliness model, for example, through feeding forward and backpropagation while adjusting one or more features of the timeliness model or by a maximum likelihood method. In some embodiments, the clinical investigation system 110 utilizes a holdout set of training data to validate the accuracy of the timeliness model. The clinical investigation system 110 may iteratively train the timeliness model (refining the model) as additional clinical investigations come to a close and are completed.

FIG. 4B is a flowchart illustrating predicting timeliness for a clinical investigation using the timeliness model, according to one or more embodiments. The clinical investigation system 110 manages an active clinical investigation being monitored for its timeliness.

The clinical investigation system 110 monitors 440 the active clinical investigation. Monitoring may include obtaining data on the clinical investigation. For example, and as disclosed elsewhere, the monitored data includes factors such as a current duration of the clinical investigation, one or more clinical investigators assigned to the clinical investigation, the clinical reviewer's years of experience or number of completed investigations, break days, a department of the clinical investigator, external factors caused by third-party vendors, etc.

The clinical investigation system 110 applies 450 the trained timeliness model to determine a timeliness prediction of the clinical investigation. The clinical investigation system 110 may generate a feature vector based on the monitored data. The trained timeliness model may be trained according to the method 400 of FIG. 4A. The timeliness prediction indicates whether the clinical investigation is predicted to complete on-time or be overdue. The timeliness prediction may further predict the likelihood of being on-time or being overdue, one or more symptoms contributing heavily to the prediction, etc.

The clinical investigation system 110 identifies 460 one or more interventive actions based on the timeliness prediction. The clinical investigation system 110 can identify the actions using a suggestion model (e.g., as described under the intervention suggestion module 240 in FIG. 2).

The clinical investigation system 110 generates 470 a notification including the timeliness prediction and one or more interventive actions. The notification may be formatted as an email report, within a GUI, as a mobile device pop-up notification, etc.

In one or more embodiments, the clinical investigation system 110 may iteratively monitor a current clinical investigation's timeliness. The clinical investigation system 110 may also utilize the method 430 to evaluate effectiveness of one or more interventive actions. For example, the supervisor or other management personnel may employ an interventive action. After some duration of time to allow for the interventive action to take effect, the clinical investigation system 110 may once again predict timeliness to evaluate whether the interventive actions had an effect on the timeliness.

In other embodiments, the clinical investigation system 110 may display a GUI for the supervisor or management personnel to toggle inputs to simulate interventive actions. For example, the GUI may have a slider as to the factor of clinical reviewer's years of experience to understand whether transitioning the clinical investigation to another clinical reviewer with more experience will significantly improve the timeliness.

### Example Implementations

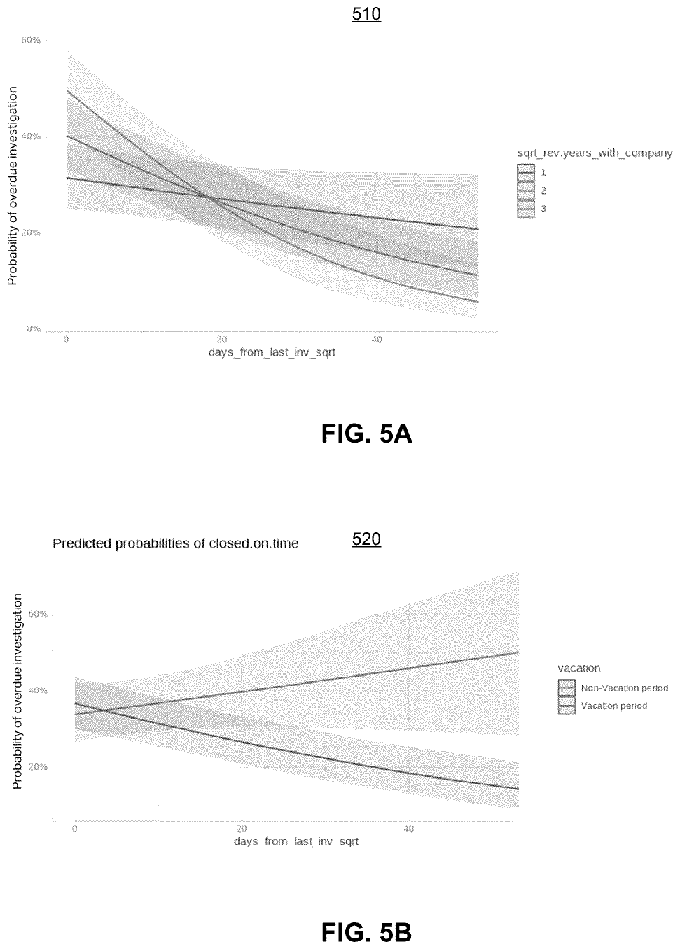

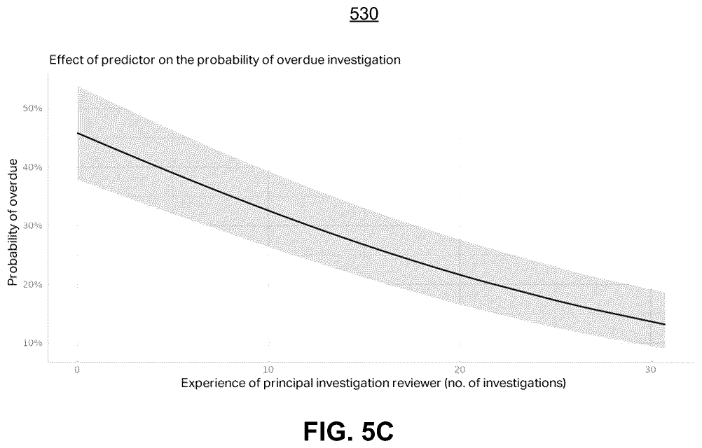

FIGS. 5A-5C are graphs illustrating the effect on timeliness of various factors demonstrating the predictability of the timeliness model. The y-axis illustrates prediction on likelihood of overdue (%) with the x-axis tracking square root of days from last investigation for the clinical investigator in 5A-5B and experience of reviewer on 5C.

FIG. 5A is a first graph 510 illustrating the effect on timeliness that a clinical reviewer's years of experience has combined with the workload of the clinical investigator, according to one or more example implementations. The first graph illustrates three categories for a clinical reviewer's square root years of experience (1, 2, or 3+). The largest slope is for reviewers with square root of 3 or more years of experience, with a higher predicted likelihood of overdue from 0 days since last investigation but with a significant likelihood of overdue decline as the days increase. The smallest slope is for reviewers with one or less years of experience, with a lower predicted likelihood of overdue from day 0, but ending with a higher predicted likelihood of overdue the further out from the last investigation that the clinical investigator handled. The slope for reviewers with square root 2 years of experience runs in between the 1-year regression and the square root 3-year+ regression.

FIG. 5B is a second graph 520 illustrating the effect on timeliness that a vacation period has, according to one or more example implementations. The vacation period factor is binary, whether a vacation period was taken or not. With a vacation period, there is a positive slope, increasing predicted likelihood of overdue with more days from last investigation. Without a vacation period, there is a negative slope, which indicates that non-vacation period combined with lower workload for the investigator (higher number of days from last investigation) reduces the probability of an overdue investigation.

FIG. 5C is a third graph 530 illustrating the effect on timeliness that a clinical reviewer's investigation experience has, according to one or more example implementations. In this third graph 530, the y-axis now tracks likelihood of being overdue (%) with the x-axis tracking number of investigations completed by the reviewer. There is a sharp negative slope indicating the more experienced a reviewer, the less probable to be overdue.

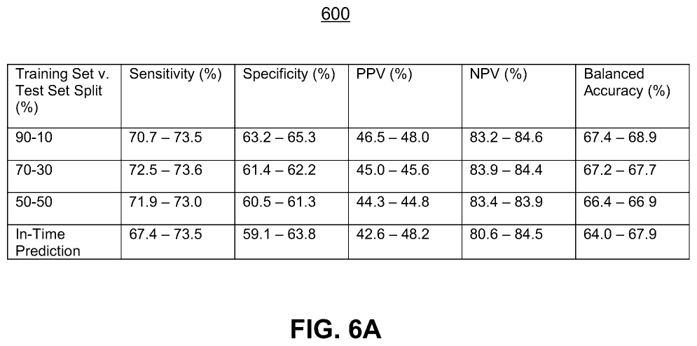

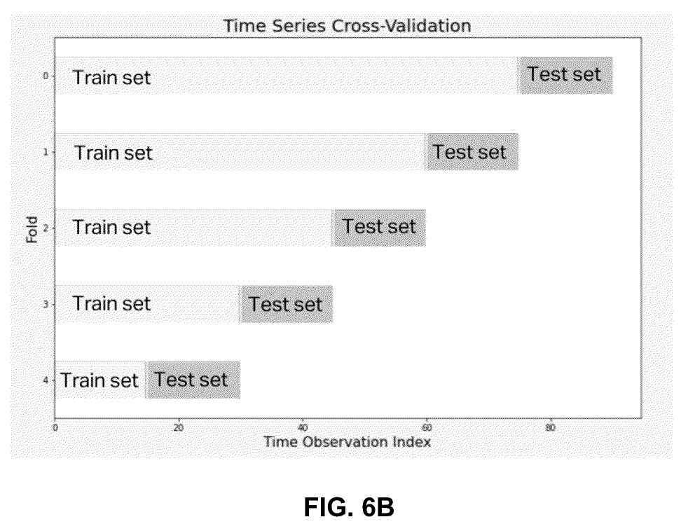

FIG. 6A is a table 600 with classification accuracy metrics of the timeliness model, according to one or more example implementations. The table illustrates three different training v. holdout ratios used while training and validating the timeliness model. The first row utilized 90% of the historical clinical trials to train the timeliness model leaving 10% for holdout and validation. The second row utilized 70% for training and 30% for holdout. The third row utilized 50% for training and 50% for holdout. The fourth row utilized an in time repeated prediction as shown in the cross-validation graph in FIG. 6B. The sensitivity was on average ˜70%, with balanced accuracy at ˜65%.

FIG. 7A illustrates a first portion 710 of an example graphical user interface, according to one or more example implementations. The first portion 710 includes two panels. In panel 712, there is a distribution of the current active clinical investigations. There are four colors used to distinguish the timeliness predicted of the active clinical investigations. Green refers to negligible likelihood of being overdue; yellow refers to low likelihood of being overdue; orange refers to substantial likelihood of being overdue; and red refers to high likelihood of being overdue. Between each of the colored “risk” groupings, the clinical investigations can be further split based on distributions overall (“total”), distribution last month (“Previous Month”), and distribution this month (“Current Month”). Panel 714 illustrates individualized information on the clinical investigations. One may toggle which columns are shown, but generally provides identifying information (columns entitled “PR.ID”, “Department”), timeliness prediction (columns entitled “Prediction”, “Odds of Overdue”, and “Risk Class”), and potential contributing factors (column entitled “Symptom”).

FIG. 7B illustrates a second portion 720 of an example graphical user interface, according to one or more example implementations. The second portion 720 includes three panels. In panel 722, the GUI can display additional information on the factors for a selected active clinical investigation. The symptoms can also be ranked (as shown) based on their levels of contribution to the timeliness prediction. Panel 724 illustrates a graphical indicator of the timeliness prediction, e.g., shown as a circular gauge with varying sections demarcated for the risk classes. The circular gauge can provide a visual indication as to the severity of the overdue prediction of a clinical investigation. Panel 726 illustrates a possible way to intervene and estimate alternative probabilities of overdue based on different investigators and reviewers for a specific investigation.

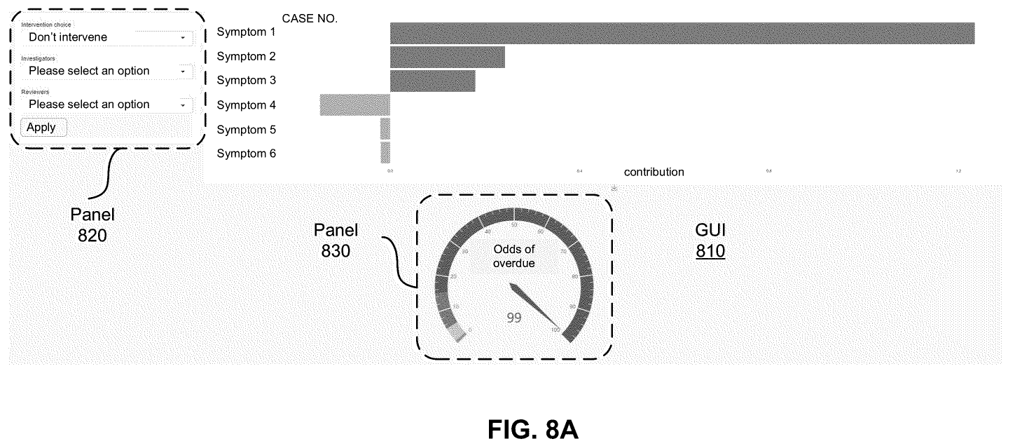

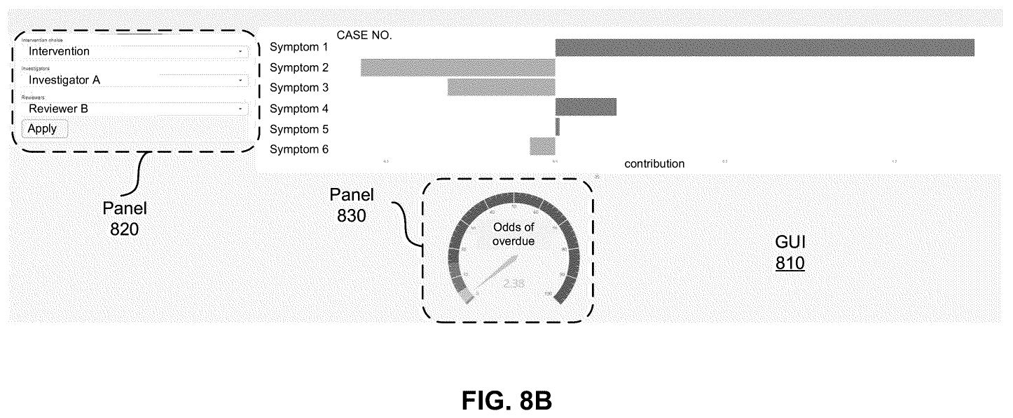

FIG. 8A illustrates an example graphical user interface 810 prior to intervention, according to one or more example implementations. The graphical user interface 810 is an embodiment of a user interface generated by the user interface module 210. The graphical user interface 810 displays, among other things, a distribution of active clinical investigations classified according to timeliness (e.g., as in FIG. 7A). The graphical user interface 810 may further display particular information relating to each clinical investigation with prediction of timeliness. For example, the clinical investigation with identifier “71526” is highlighted with additional information indicating which department the clinical investigation is within, prediction on timeliness, symptom contributing to timeliness prediction, the likelihood of being overdue, etc.

The graphical user interface 810 further includes panel 820 which provides an intervention option. The intervention option is configured to receive user input with a candidate intervention. As exampled in FIG. 8A, the intervention option includes three dropdown menus for providing user input to a candidate intervention. The first dropdown menu may receive input indicating whether the user (e.g., the supervisor 330) wants to intervene. The second dropdown menu may receive input indicating which investigator to switch the clinical investigation to. The third dropdown menu may receive input indicating which reviewer to switch the clinical investigation to. The intervention option in panel 820 may further comprise a togglable input for enacting the chosen intervention (i.e., the “Apply” button). Upon receiving user input for enacting the chosen intervention, the clinical investigation management system 110 may enact the intervention (e.g., sending notification to an investigator, a reviewer, etc., and, optionally, with one or more action items). The intervention option in panel 820 may comprise any number of togglable inputs for providing a candidate intervention and/or for any intervention type.

The graphical user interface 810 further includes panel 830 which provides an indication to likelihood of being overdue for a selected clinical investigation. As shown in FIG. 8A, the indicator may be in the form of a speedometer.

FIG. 8B illustrates the example graphical user interface of FIG. 8A post candidate intervention input, according to one or more example implementations. In the example shown in FIG. 8B, a user (e.g., a supervisor) may provide a candidate intervention as input to the intervention option in panel 820. The user interface module 210 may automatically (or as triggered by the “Apply” button) update the indicator in panel 830 showing the likelihood of being overdue for the selected clinical investigation.

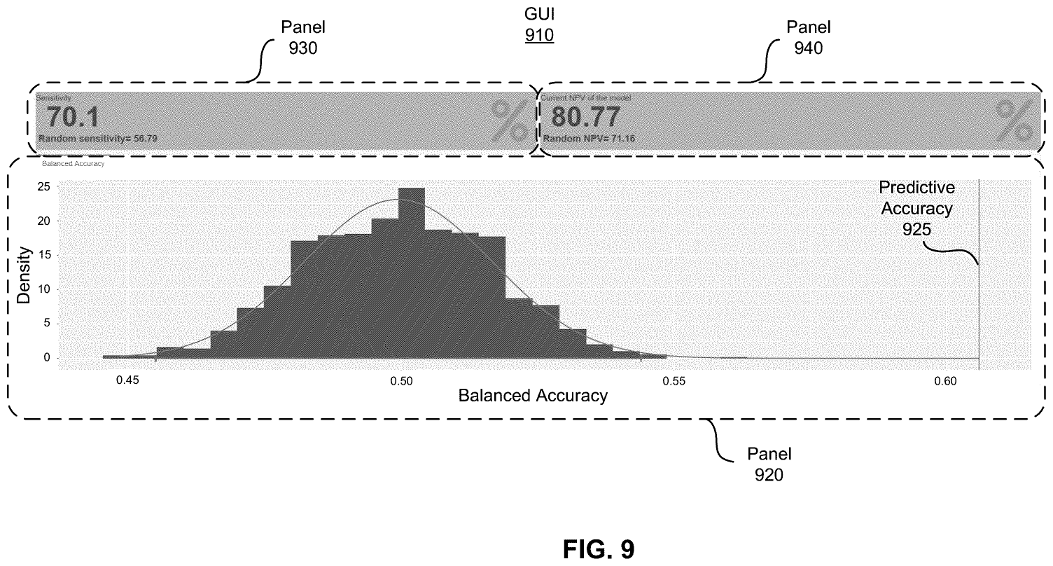

FIG. 9 illustrates an example graphical user interface 910, according to one or more example implementations. The graphical user interface 910 is an embodiment of a user interface generated by the user interface module 210. The graphical user interface 910 as illustrated in FIG. 9 includes panel 920, panel 930, and panel 940. Panel 920 displays a distribution of balanced accuracy of past-predicted clinical investigations. The vertical line (just above 0.60) on balanced accuracy indicates the arithmetic mean of sensitivity and specificity. Panel 930 illustrates sensitivity of the timeliness model. Panel 940 depicts the Negative Predictive Value (NPV) of the model. The Negative Predictive Value is the ratio of investigations truly predicted as “closed on time” to all those which were predicted as “closed on time” (including incorrectly predicted investigations). A high NPV indicates the confidence in calling “closed on time” to actually “closed on time.” The predictive accuracy 925 of the timeliness prediction model is represented by the vertical line showing the balanced accuracy of the timeliness prediction model on past investigations that are closed (e.g., not included in the training set). The distribution curve (95% confidence interval is from ˜0.46 to ˜0.54) represents the distribution of balanced accuracy in case of random predictions. If the predictive accuracy drops below the upper level of the confidence interval, then the system may provide an email regarding such drop in predictive accuracy of the timeliness prediction model.

### Computing Machine Architecture

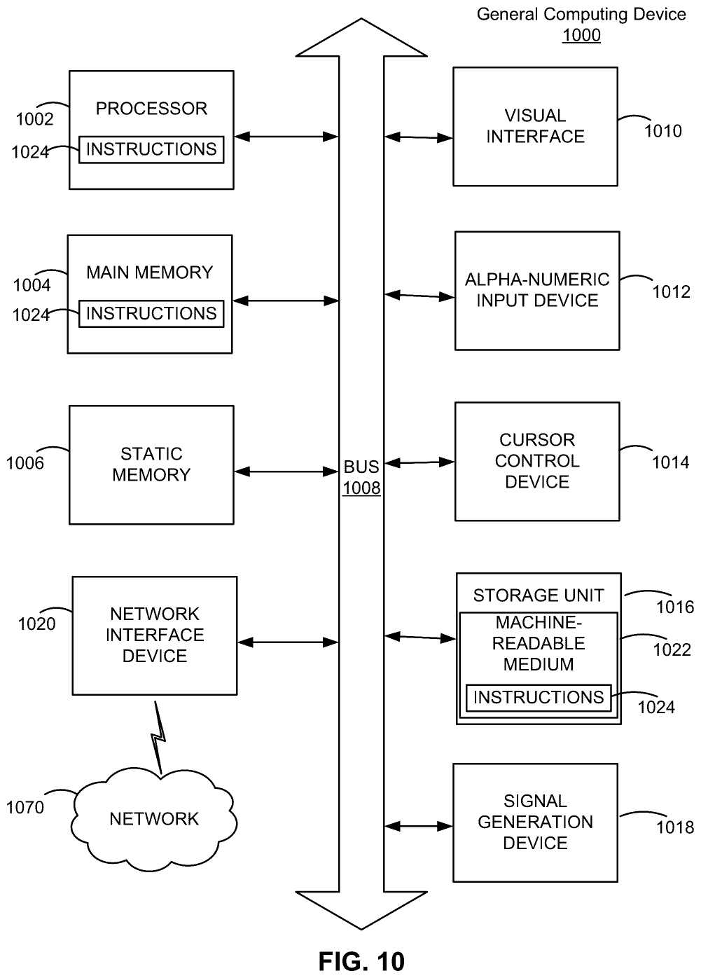

FIG. 10 is a block diagram illustrating components of an example machine able to read instructions from a machine-readable medium and execute them in a processor (or controller). Specifically, FIG. 10 shows a diagrammatic representation of a machine in the example form a computer system 1000, within which program code (e.g., software or software modules) for causing the machine to perform any one or more of the methodologies discussed herein may be executed. The program code may be comprised of instructions 1024 executable by one or more processors 1002. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 1024 (sequential or otherwise) that specify actions to be taken by that machine. Further, while only a single machine is illustrated, the term “machine” shall also be taken to include any collection of machines that individually or jointly execute instructions 1024 to perform any one or more of the methodologies discussed herein.

The example computer system 1000 includes a processor 1002 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 1004, and a static memory 1006, which are configured to communicate with each other via a bus 1008. A processor 1002 may comprise one or more sub-processing units. The computer system 1000 may further include visual display interface 1010. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 1010 may include or may interface with a touch enabled screen. The computer system 1000 may also include alphanumeric input device 1012 (e.g., a keyboard or touch screen keyboard), a cursor control device 1014 (e.g., a mouse, a trackball, a joystick, a motion sensor, or other pointing instrument), a storage unit 1016, a signal generation device 1018 (e.g., a speaker), and a network interface device 1020, which also are configured to communicate via the bus 1008.

The storage unit 1016 includes a machine-readable medium 1022 on which is stored instructions 1024 (e.g., software) embodying any one or more of the methodologies or functions described herein. The instructions 1024 (e.g., software) may also reside, completely or at least partially, within the main memory 1004 or within the processor 1002 (e.g., within a processor's cache memory) during execution thereof by the computer system 1000, the main memory 1004 and the processor 1002 also constituting machine-readable media. The instructions 1024 (e.g., software) may be transmitted or received over a network 190 via the network interface device 1020.

While machine-readable medium 1022 is shown in an example embodiment to be a single medium, the term “machine-readable medium” should be taken to include a single medium or multiple media (e.g., a centralized or distributed database, or associated caches and servers) able to store instructions (e.g., instructions 1024). The term “machine-readable medium” shall also be taken to include any medium that is capable of storing instructions (e.g., instructions 1024) for execution by the machine and that cause the machine to perform any one or more of the methodologies disclosed herein. The term “machine-readable medium” includes, but not be limited to, data repositories in the form of solid-state memories, optical media, and magnetic media.

### Additional Configuration Considerations

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across one or more machines, e.g., computer system 700. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. It should be noted that where an operation is described as performed by “a processor,” this should be construed to also include the process being performed by more than one processor. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for providing CMC change assessment through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the disclosed principles.

What is claimed is:

1. A computer-implemented method for predicting timeliness in completion of clinical investigations, the method comprising:
monitoring data of a clinical investigation performed by a clinical investigator;
applying a timeliness model to the data to determine a timeliness prediction of the clinical investigation;
identifying an interventive action based on the timeliness prediction;
generating a notification including the timeliness prediction and the identified interventive action; and
transmitting the notification to a client device of a supervisor.

2. The computer-implemented method of claim 1, further comprising:
generating a graphical user interface displaying the clinical investigation, the timeliness prediction, and one or more inputs configured to be adjusted by the supervisor; and
transmitting the graphical user interface to the client device of the supervisor.

3. The computer-implemented method of claim 2, further comprising:
receiving, via a first input on the graphical user interface, a user input adjusting a first factor of the clinical investigation simulating an interventive action;
applying the timeliness model to the data of the clinical investigation with the adjusted first factor to determine a second timeliness prediction; and
updating the graphical user interface to display the second timeliness prediction.

4. The computer-implemented method of claim 1, wherein the data of the clinical investigation comprises a combination of factors:
a clinical reviewer's years of experience;
a department the clinical investigator is a part of;
a duration of time since beginning of the clinical investigation;
a number of break days during the clinical investigation;
days from last investigation that a clinical investigator has handled;
historical timeliness of the clinical reviewer; and
one or more external factors from third-party vendors.

5. The computer-implemented method of claim 1, wherein the timeliness prediction indicates a likelihood of the clinical investigation not completing on time.

6. The computer-implemented method of claim 5, wherein the timeliness prediction further indicates a number of days predicted to be overdue.

7. The computer-implemented method of claim 1, wherein the timeliness model is configured to further identify one or more factors mainly contributing to the timeliness prediction.

8. The computer-implemented method of claim 1, wherein applying the timeliness model to the data comprises:
identifying first value for a first factor of the clinical investigation;
selecting a first sub-model associated with the first value from a plurality of sub-models, each sub-model associated with a different value for the first factor; and
applying a first sub-model to determine the timeliness prediction.

9. The computer-implemented method of claim 1, wherein the timeliness model is a machine-learning model.

10. The computer-implemented method of claim 1, wherein identifying the one or more interventive actions is based on past historical interventive actions enacted for the clinical investigator.

11. The computer-implemented method of claim 10, wherein one or more interventive actions are excluded from recommendation to the clinical investigator.

12. A non-transitory computer-readable storage medium storing instructions for predicting timeliness in completion of clinical investigations, the instructions, when executed by a computer processor, causing the processor to perform operations comprising:
monitoring data of a clinical investigation performed by a clinical investigator;
applying a timeliness model to the data to determine a timeliness prediction of the clinical investigation;
identifying an interventive action based on the timeliness prediction;
generating a notification including the timeliness prediction and the identified interventive action; and
transmitting the notification to a client device of a supervisor.

13. The non-transitory computer-readable storage medium of claim 12, the operations further comprising:
generating a graphical user interface displaying the clinical investigation, the timeliness prediction, and one or more inputs configured to be adjusted by the supervisor; and
transmitting the graphical user interface to the client device of the supervisor.

14. The non-transitory computer-readable storage medium of claim 13, the operations further comprising:
receiving, via a first input on the graphical user interface, a user input adjusting a first factor of the clinical investigation simulating an interventive action;
applying the timeliness model to the data of the clinical investigation with the adjusted first factor to determine a second timeliness prediction; and
updating the graphical user interface to display the second timeliness prediction.

15. The non-transitory computer-readable storage medium of claim 12, wherein the timeliness prediction indicates a likelihood of the clinical investigation not completing on time.

16. The non-transitory computer-readable storage medium of claim 15, wherein the timeliness prediction further indicates a number of days predicted to be overdue.

17. The non-transitory computer-readable storage medium of claim 12, wherein the timeliness model is configured to further identify one or more factors mainly contributing to the timeliness prediction.

18. The non-transitory computer-readable storage medium of claim 12, wherein applying the timeliness model to the data comprises:
identifying first value for a first factor of the clinical investigation;
selecting a first sub-model associated with the first value from a plurality of sub-models, each sub-model associated with a different value for the first factor; and
applying a first sub-model to determine the timeliness prediction.

19. The non-transitory computer-readable storage medium of claim 1, wherein identifying the interventive action is based on past historical interventive actions enacted for the clinical investigator

20. A system for predicting timeliness in completion of clinical investigations, the system comprising:
a computer processor; and
a non-transitory computer-readable storage medium storing instructions, the instructions, when executed by the computer processor, causing the computer processor to perform operations comprising:
monitoring data of a clinical investigation performed by a clinical investigator;
applying a timeliness model to the data to determine a timeliness prediction of the clinical investigation;
identifying an interventive action based on the timeliness prediction;
generating a notification including the timeliness prediction and the identified interventive action; and
transmitting the notification to a client device of a supervisor.
